(19) United States
(12) Patent Application Publication
(10) Pub. No.: US 2010/0178881 A1
(43) Pub. Date: Jul. 15, 2010

(54) ELECTRONIC DEVICE FOR DETECTION AND STORAGE OF RDS SIGNAL DATA

(76) Inventor: Luigi De Lorenzo, Palermo (IT)

Correspondence Address: BIRCH STEWART KOLASCH & BIRCH, PO BOX 747, FALLS CHURCH, VA, 22040-0747, US

(21) Appl. No.: 12/602,342

(22) PCT Filed: Jan. 10, 2008
(86) PCT No.: PCT/IB08/50075

§ 371 Date: Nov. 30, 2009

(30) Foreign Application Priority Data
Jan. 24, 2007 (IT) VI2007A000018

(51) Int. Cl. H04B 1/02

(52) U.S. Cl. 455/91

(57) ABSTRACT

An electronic device for detection and storage of RDS signal data comprises a first microprocessor unit for detecting and processing a data signal (IN) associated to a RDS signal received from a radio receiver unit (R). The first microprocessor unit has at least one output data signal (OUT), a main storage device for storing the output data signal (OUT) from the first microprocessor unit, transmission means for transmitting the output signal (OUT) between the first microprocessor unit and the main storage device. Normally open switch means are provided, which are designed to be operated by a user to selectively enable transmission of the output signal (OUT) to the main storage device.

### FIELD OF THE INVENTION

This invention finds application in the field of electronic devices and particularly relates to an electronic device for detection and storage of data in a RDS signal associated to a radio signal.

### BACKGROUND ART

RDS (Radio Data System) signal is known to be an auxiliary encoded signal which accompanies a normal radio signal to allow identification or transmission of control data or messages at the same time as the radio program with which it is associated.

According to a well-established standard, RDS signal is a continuous string of binary data organized in 104 bits-long groups, each divided into four blocks of 26 bits. Each block is in turn divided into a first 16-bit portion, containing the encoded information to be transmitted and a second 10-bit portion that is used for checking and correcting the transmitted data.

The codes associated to a RDS signal can be used as an aid for tuning the receiver, such as the PI code for broadcast programme identification and the TP code for traffic programme identification, for managing secondary applications or for transmitting switching signals.

For instance, the code RT (Radio Text) allows transmission of brief auxiliary text messages to indicate the broadcasting station name, the title and author of a tune or to transmit any information whatever.

Text messages are later decoded by the radio receiver and shown on a display or converted into voice through a voice synthesizer.

Several different electronic devices are currently available, which manage one or more parts of the RDS signal to allow storage or display of information associated to the main radio signal.

Devices are known which are designed to determine the radio signals with which a TP code is associated for later automatic tuning of the radio receiver to the radio channel frequency that has such code or for storage of such radio signal on a storage media.

Nevertheless, such apparatus allow storage of the radio signal only and not of the RDS code associated therewith, wherefore a user could only be given auxiliary information associated with the radio signal, such as RT code information, when the signal reaches the receiver.

In an attempt to obviate the above drawbacks, devices have been developed for storage of one or more portions of the RDS signal on a storage media.

U.S. Pat. No. 6,038,434 discloses an apparatus for receiving and displaying data associated to a RDS signal transmitted along with a radio signal and having an antenna for receiving the radio signal, a RDS signal decoder and a RAM memory for storage of the RT code associated to the signal. The information so stored can be later retrieved by a user by selecting an appropriate key and recalled on the display of the radio receiver unit.

While this solution allows text information to be displayed, such as the title or author of one or more tunes broadcast by a radio broadcasting station, it still stores information in an uncontrolled manner, also recording information of little or no interest to the user of the device.

Therefore, if the storage media does not have an adequate capacity, there will be the risk that it can become saturated in little time, thereby preventing storage of all necessary information.

Furthermore, prior art devices do not allow transfer from the storage to other apparatus for processing and management of stored information or for use of such information for management of multimedia services.

### SUMMARY OF THE INVENTION

The object of the present invention is to overcome the above drawbacks, by providing an electronic device for detection and storage of RDS signal data that is highly efficient and relatively cost-effective.

A particular object is to provide an electronic device that allows the user to only store the RDS signal data of interest to him/her, thereby preventing the storage device from becoming saturated with data not requested by the user.

A further object of the present invention is to provide an electronic device that can interface with other external devices for displaying and/or processing of stored data in a simple and immediate manner even for inexpert users.

These and other objects, as better explained hereafter, are fulfilled by an electronic device for detection and storage of RDS signal data in accordance with claim 1, comprising a first microprocessor unit for detecting and processing a data signal associated to a RDS signal received from a radio receiver unit, said first microprocessor unit having at least one output data signal, a main storage device for storing the output data signal from the first microprocessor unit, means from transmitting the output signal between the first microprocessor unit and the main storage device.

According to the invention, the device includes normally open switch means, which are designed to be operated by a user to selectively enable transmission of the output signal from the microprocessor to the main storage device.

Thanks to this particular configuration, the device of the invention allows the user to only store RDS signal-associated data of such data are of interest to him/her.

This may prevent the storage device from being overloaded with useless data which would cause it to become saturated in relatively little time.

Advantageously, the main storage device may be of the removable type and preferably selected from the group comprising memory cards, mobile devices, MP3 players and similar devices.

Thus, the information stored in the electronic device of the invention may be easily transferred to one or more external devices for processing and/or management, such as personal computers, MP3 players, cellular phones, handheld computers and the like.

Suitably, the electronic device may contain a second microprocessor unit for decoding the input RDS signal from the radio receiver unit.

Thanks to this last feature, the electronic device may be also used in combination with radio receiver units having no RDS decoder, thereby considerably increasing their versatility of operation.

### BRIEF DESCRIPTION OF DRAWINGS

Further features and advantages of the invention will be more apparent from the detailed description of a preferred, non-exclusive embodiment of an electronic device according to the invention, which is described as a non-limiting example with the help of the annexed drawings, in which:

FIG. 1 is a diagram of a first preferred embodiment of the electronic device of the invention;

FIG. 2 is a diagram of a second preferred embodiment of the electronic device of the invention;

FIGS. 3a, 3b are front views of a common radio receiver unit incorporating the electronic device of the invention.

### DETAILED DESCRIPTION OF A PREFERRED EMBODIMENT

Referring to the above figures, the electronic device of the invention, generally designated with numeral 1, may be associated with a radio receiver unit R of common use, such as a radio set, a car radio or similar unit, for detecting and storing data in the RDS signal associated to the input radio signal to the radio receiver unit R.

The electronic device 1 may be incorporated in the radio receiver unit R, or associated thereto in a wholly or partially removable manner.

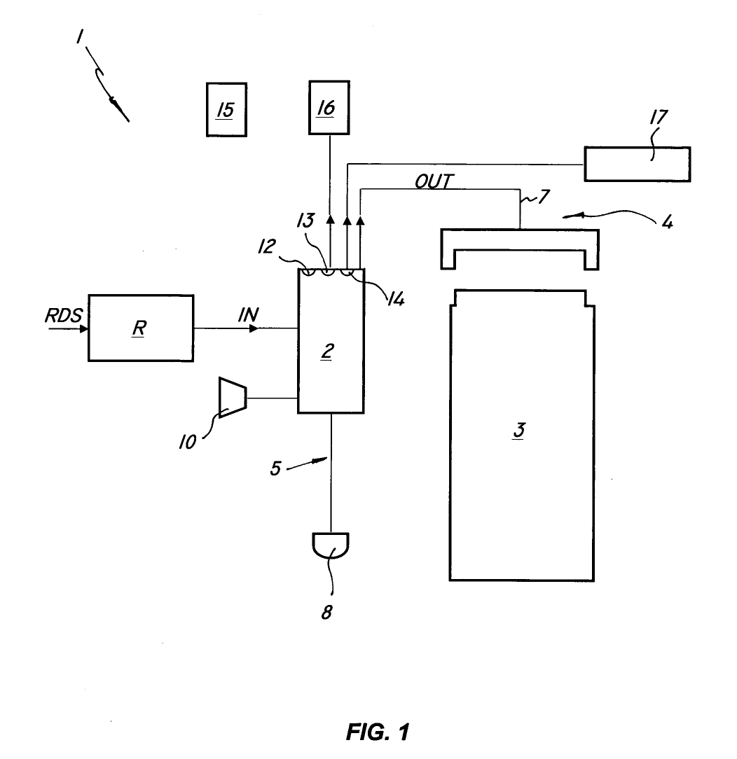

As diagrammatically shown in FIG. 1, the electronic device of the invention comprises a first microprocessor unit 2 which is designed to be connected to an external radio receiver unit R adapted to receive a radio signal in any frequency band and to extract the RDS signal therefrom.

The first microprocessor unit 2 detects and processes one or more data signals IN associated to the input RDS signals from the radio receiver unit R and then generates an output data signal OUT directed to a main storage device 3 for storage thereof. Transmission means 4 are further provided for transmitting the output signal OUT from the first microprocessor unit 2 to the main storage device 3.

According to a peculiar feature of the invention, the electronic device 1 further includes normally open switch means 5, which are designed to be operated by a user to selectively enable transmission of the output signal OUT from the microprocessor unit 2 to the main storage device 3.

Thus the device 1 can be only operated in the presence of a RDS signal containing information of actual interest to the user.

Furthermore, the main storage device 3 will not be overloaded with useless information, wherefore its capacity will not be quickly saturated, and the main storage device 3 can be selected among those of small size, thereby affording considerable savings.

The information in the input data signal IN can include RDS-relevant information associated with RT, PS, PI codes or the like, such as the title and artist of a tune, the name and country of the broadcasting station to whose frequency the radio receiver unit R is tuned or other accessory information.

According to the configuration of FIG. 1, the electronic device 1 shall receive the RDS signal when the latter has been decoded by the external radio receiver unit R for later processing of the data signal IN through the first microprocessor unit 2.

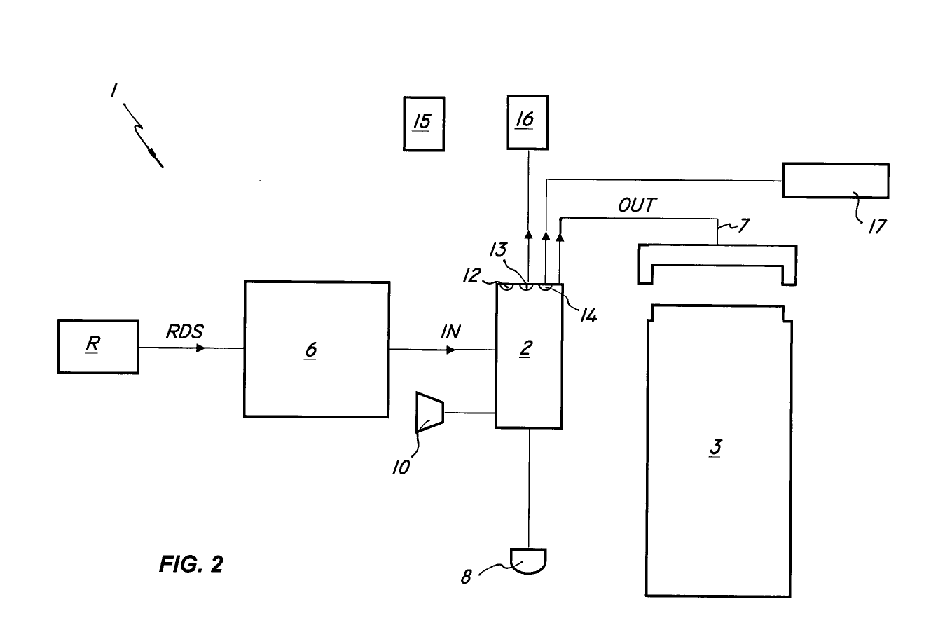

In the preferred but not exclusive configuration of FIG. 2, as schematically shown in FIG. 2, the electronic device will include a second microprocessor unit 6 which will decode the RDS input signal from the radio receiver unit R to generate the input signal IN to the first microprocessor unit 2.

This will considerably increase the versatility of the whole device 1, because the device 1 can be also used with radio receiver units having no dedicated RDS decoder.

In both illustrated configurations, as well as in other configurations of the device of the invention, not shown, the transmission means 4 may include a transmission line 7 for connecting the first microprocessor unit 2 with the main storage device 3.

According to an alternative configuration, not shown, the transmission means 4 may be of the wireless type, to allow remote connection of the first microprocessor unit 2 with one or more storage devices 3, not necessarily identical, through a predetermined transmission protocol that uses known technologies, such as Bluetooth, wideband, Wi-Fi, IRda and the like.

Furthermore, FIGS. 1 and 2 show that the switch means 5 may be placed upstream from the transmission line 7 and may include a pushbutton 8 to be actuated from the outside by a user.

Nevertheless, the switch means 5 may be also incorporated in the first microprocessor unit 2 or in the transmission line 7 itself, without departure from the scope of the present invention.

Alternative to the pushbutton 8, remotely controllable switch means 5 may be provided, which can be actuated by the user by means of a remote control, when a data signal IN associated to the RDS signal will be present in the first microprocessor unit 2.

According to a preferred, non exclusive configuration of the invention, the main storage device 3 may be of the removable type and may be selected from the group comprising memory cards of any type, mobile devices such as Pocket PCs, Smartphones, cellular phones, satellite navigators, MP3 players, Pen Drives and the like, which are commonly available.

Thus, all the information in the main storage device 3 may be transferred in a very quick and easy manner to an ordinary external computer, not shown, for easy consultation by the user, and for possible use for other applications, such as for on-like purchase transactions.

The first microprocessor unit 2 may be also selected from the group of commonly available electronic components.

Advantageously, the electronic device 1 may include first signaling means 9 for signaling the presence of the data signal IN in the first microprocessor unit 2.

Furthermore, the first microprocessor unit 2 may include second signaling means 10 for indicating that storage of the output signal OUT on the main storage device 3 has been completed.

Both the first 9 and the second signaling means 10 may be of either the optical type, such as LEDs or the like, or of the acoustic type.

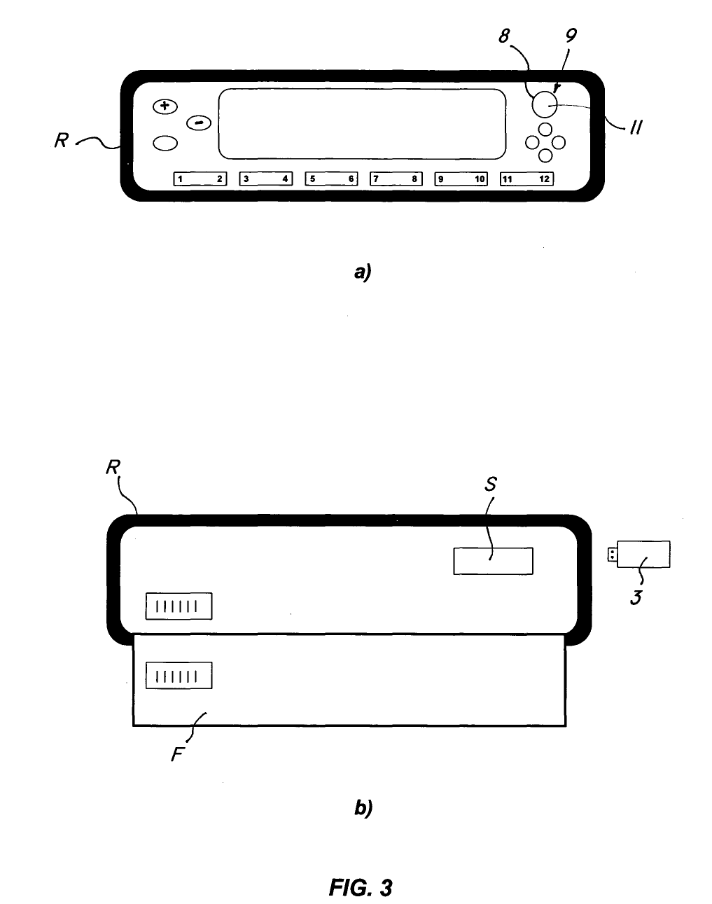

Particularly, the first signaling means 9 may be incorporated in the switch means 5, and be embodied as a pushbutton 8 having an incorporated LED susceptible of being turned on when a data signal IN will be present in the first microprocessor unit 2, as shown in FIG. 3a.

On the other hand, the second signaling means 10 may include an audio device, not shown, that will deliver a sound signal as storage of the data signal OUT on the main storage device 3 will be completed.

The same FIG. 3a shows a common car audio R incorporating the device 1 of the invention, whereof the button 8 incorporating the signaling LED 11 is only visible.

FIG. 3b shows the same car audio R with the front panel F tilted to expose the connection port S of the main storage device 3, which in this case is of the removable type.

Also, the electronic device 1 may include one or more ports, e.g. the three ports 12, 13, 14 as shown in the figures, for connection thereof to additional secondary storage devices 15, 16 selected from the same group as the main storage device 3.

Furthermore, one or more of these ports, such as the port 12, may be designed for wireless connection with its respective secondary storage device 15, whereas another port 14 may be connected to display means 17 for immediate display of the information in the data signal IN.

In a possible mode of operation of the device 1 of the invention, once a data signal IN associated with the RDS signal has been received, the first microprocessor unit 2 checks for the presence of a useful code, such as a RT, PS, PI codes or the like, and if one such code is found, it enables the signaling means 9 which were initially off.

For instance, if the first signaling means 9 are of the optical type, this may cause the LED 11 or any other similar suitable device, to turn on.

Then, the user may decide to enable storage of the information in the data signal IN by operating the switch means 5.

As the switch means 5 are turned on, the second signaling means 10 can be also enabled, for instance by causing the same LED 11 as used by the first signaling means 9 to flash.

In case of improper reception of the data signal IN during storage, due to external factors, such an attenuation or a suppression of the radio signal due to a shadow region, the first microprocessor unit 2 may generate an input to the second signaling means 10 to disable flashing mode operation of the LED 11.

In case of proper reception of the data signal IN, once the latter has been stored on the main storage device 3, the second signaling means 10 may transmit a signal, e.g. a sound signal, while disabling the first signaling means 9 and turning the LED 11 off.

Now, the first microprocessor unit 2 may take control of the first signaling means 9 again to enable the device 1 for storage of a new data signal IN.

The above disclosure clearly shows that the invention fulfils the intended objects, and particularly meets the requirement of providing an electronic device for detection and storage of RDS signal data, that allows the user to only store the RDS signal data of interest to him/her.

Thanks to its particular configuration, the device of the invention may be connected to one or more external devices of known type for displaying and processing the stored information in a simple and quick manner even by inexpert users.

The electronic device of this invention is susceptible of a number of changes and variants, within the inventive concept disclosed in the appended claims. All the details thereof may be replaced by other technical equivalents, and the materials may vary depending on different needs, without departure from the scope of the invention.

While the electronic device has been described with particular reference to the accompanying figures, the numerals referred to in the disclosure and claims are only used for the sake of a better intelligibility of the invention and shall not be intended to limit the claimed scope in any manner.

1. An electronic device for detection and storage of RDS signal data, the device being adapted to be associated to a radio receiver unit, comprising:
a first microprocessor unit that detects and processes a data signal associated to a RDS signal received from a radio receiver unit, said first microprocessor unit having at least one output data signal;
a main storage device that stores said at least one output data signal from said first microprocessor unit;
a transmission that transmits the output data signal between said first microprocessor unit and said main storage device; and
at least one normally open switch designed to be operated by a user to selectively enable transmission of said output data signal to said main storage device.

2. The electronic device as claimed in claim 1, wherein said transmission comprises a transmission line that connects said first microprocessor unit to said main storage device.

3. The electronic device as claimed in claim 1, wherein said transmission is of the wireless type.

4. The electronic device as claimed in claim 1, wherein said at least one switch is incorporated in said first microprocessor unit.

5. The electronic device as claimed in claim 2, wherein said at least one switch is incorporated in said transmission line.

6. The electronic device as claimed in claim 2, wherein said at least one switch is located upstream of said transmission line.

7. The electronic device as claimed in claim 1,
wherein said at least one switch includes a pushbutton actuatable from the outside by a user.

8. The electronic device as claimed in claim 1, wherein said at least one switch is of the remotely controllable type.

9. The electronic device as claimed in claim 1, wherein said main storage device is of the removable type.

10. The electronic device as claimed in claim 9, wherein said removable storage device is selected from the group comprising memory cards, mobile devices, and MP3 players.

11. The electronic device as claimed in claim 1, further comprising a first signaling device that signals the presence of said at least one data signal in said first microprocessor unit.

12. The electronic device as claimed in claim 1, wherein said first microprocessor unit includes a second signaling device that indicates that storage of said output data signal on said main storage device has been completed.

13. The electronic device as claimed in claim 11, wherein said first and/or second signaling device is of the optical type, of the LED type or similar optical devices.

14. The electronic device as claimed in claim 11, wherein said first and/or second signaling device is of the acoustic type.

15. The electronic device as claimed in claim 1, further comprising a second microprocessor unit that decodes a RDS input signal from a radio receiver unit to generate said input signal to said first microprocessor unit.

16. The electronic device as claimed in claim 1, wherein said first microprocessor unit includes one or more ports for connection to additional secondary storage devices.

17. The electronic device as claimed in claim 16, wherein at least one of said ports is designed for wireless connection with at least one of said secondary storage devices.

18. The electronic device as claimed in claim 16, further comprising a display (17) device connected to one of said ports.

19. The electronic device as claimed in claim 1, wherein said data signal is encoded using RT, PS, or Pl codes.
